(19) United States
(12) Patent Application Publication
(10) Pub. No.: US 2002/0111835 A1
(43) Pub. Date: Aug. 15, 2002

(54) Underwriting insurance

(76) Inventors: John C. R. Hele, Paget (BM); Christopher Serflek, Paget (BM)

Correspondence Address: DENIS G. MALONEY, Fish & Richardson P.C., 225 Franklin Street, Boston, MA, 02110-2804, US

(21) Appl. No.: 09/993,186

(22) Filed: Nov. 6, 2001

Related U.S. Application Data
(60) Provisional application No. 60/246,260, filed on Nov. 6, 2000.

(51) Int. Cl. G06F 17/60

(52) U.S. Cl. 705/4

(57) ABSTRACT

Disclosed is an overall process for underwriting insurance. The process can include automated underwriting using rules from a plurality of insurance carriers. Rules can be general, carrier specific, and product specific. Also featured is a reflexive process for questioning a user that is purchasing insurance.

### CROSS-REFERENCE TO RELATED APPLICATIONS

This application claims priority to U.S. provisional application No. 60/246,260 filed on Nov. 6, 2000, the contents of which are incorporated herein by reference.

### BACKGROUND

This invention relates to selling insurance.

Insurance is a useful financial instrument that protects individuals and their beneficiaries from the risk of monetary loss. For example life insurance protects beneficiaries from loss due to death. Many different life insurance plans are currently available. They can be classified into two general categories, “term life insurance,” and “whole life insurance.” Term life insurance provides coverage for a defined period, usually one year, in exchange for a premium. Some term life policies fix the premium amount for a longer period, typically up to twenty years. Term life insurance policies have no cash value, whereas the second major type of insurance, whole life insurance, generally include an investment component in the premium which often allows the owner of the policy to borrow against the face value of the insurance up to the cash value that has vested in the policy or to surrender the policy for the cash value.

The industry also features a diverse number of variations on these two plans. Plans can include a variety of investment features, variable benefits, and so forth. Similar diverse considerations apply to other types of insurance. Thus, the average individual is faced with both a daunting number of insurance products as well as a large market of many insurance carriers.

### SUMMARY

The invention provides a method, software and system for underwriting life insurance based on user profile. The method can be used to produce ratings based on the user profile and underwrite rules of a plurality of carriers. Additional features include a multi-pass underwriting process that prices life insurance policies as a function dependent on the user profile and the underwriting rules of the carriers.

In one aspect, the invention features a method that includes: receiving a first set of information about a user; displaying a first range of pricing information for a life insurance plan for the user to the user; receiving a second set of information about the user; displaying a second range of pricing information for the life insurance plan to the user; receiving quotes for the life insurance plan from a plurality of insurance carriers; and displaying the quotes to the user.

The first set of information can include, for example, information about gender, age, and tobacco use. In one embodiment, the first set of information consists of no more than five fields. For example, the first set of information consists of information about gender, age, and tobacco use.

The second set of information can include, for example, one or more of: height, weight, medical condition, family medical history, driving record, criminal record, and recreational activities. The second set of information can include information about the user from an external agency, e.g., from a medical examiner, a government agency, or a fraud prevention agency. At least part of the first set of information can received from a party other than the user, e.g., a partner site.

The method can also include receiving a third set of information, e.g., after displaying the second range of pricing information. The third set of information can include information about user identity.

In some implementations, the first set of information does not indicate the user's identity. At least some of the first and second sets of information can be received over the Internet. The first set of information can be evaluated by querying a database of rates for a plurality of insurance carriers.

The first and second range can be displayed as text or as a graph. The quotes can be indicated as locations on the graph of the second range.

The displaying of the first and second range can include sending display information across the Internet and rendering the display information in a browser. In another case, the displaying of the first and second range includes sending display information across the Internet and rendering the display information in an electronic message.

The method can further include sending a series of questions to the user prior to receiving the second set of information, wherein responses to at least some of the questions in the series determine at least some other questions in the series. At least one of the questions in the series can determine if the user is ineligible for each of a plurality of insurance carriers.

In one embodiment, the first, second, and third sets of information are sufficient to obtain quotes for life insurance from a plurality of insurance carriers.

In another aspect, the invention features a machine or computer-based method for underwriting a life insurance policy for a user. The method includes: obtaining a user profile; producing a rating for a user profile for each of a plurality of carriers; recommending to the user a first subset of carriers which produce a satisfactory or better rating; obtaining a second subset of carriers which are the user's selection from the first subset of carriers; accepting a user for underwriting by each of the second subset of carriers by filtering the user profile against a first plurality of rules of the carrier. The user profile can be obtained using the Internet. At least some of the first plurality of rules can be parameterized.

In one embodiment, producing a rating includes evaluating the user profile against a second plurality of rules that includes basic rules and carrier-specific rules.

In another embodiment, the method further includes displaying a range of pricings for the life insurance policy to the user. In still another embodiment, the method further includes identifying information required from external providers to underwrite the life insurance policy, and automatically communicating with the external providers to obtain the required information. The identifying can be effected after obtaining the second subset of carriers.

The method can also further include filtering the user profile against a second plurality of rules of the carrier to provide a quote.

The invention also features a machine-readable medium having encoded thereon machine-interpretable rules for underwriting life insurance, the rules including: a) basic rules, each basic rule applicable to a plurality of carriers; b) carrier-specific rules; and c) product-specific rules; wherein the rules enable a machine to automatically underwrite life insurance using a user profile for at least some users. The rules can be organized in a hierarchy, for each given topic, such that basic rules are evaluated prior to carrier-specific rules and carrier-specific rules are evaluated prior to product-specific rules. At least some of the rules can be parameterized. At least some of the rules can independently determine if the user can be underwritten. At least some of the rules can depend on information from an external provider, e.g., a medical examiner, government agency, or fraud-prevention agency.

In another aspect, the invention features a method of selling insurance that includes an interview process. The process orders queries sent to a user based upon answers obtained earlier in the process so that the process becomes more efficient in approving or weeding out users based on underwriting rules for a plurality of carriers. Features include ordering queries in a decision tree structure and conducting the interview process for a plurality of carriers.

Accordingly, the invention features a method of querying a user about risk during evaluation for life insurance coverage. The method includes: arranging at least one of a plurality of queries in a decision tree, such that a query precedes another query if it is more probable that an unacceptable answer to the rearranged query will result in excluding a user from purchasing insurance coverage; and issuing at least one rearranged query from the decision tree to a user.

The invention also features a server that includes a processor, memory, and a communication interface, wherein the communication interface exchanges information with a client system across a network, and the processor is configured to: receive a first set of information about a user; generate display information that enables a client system to display a first range of pricing information for a life insurance plan for the user to the user; send the display information to the client system; receive a second set of information about the user; generate additional display information that enables the client system to display a second range of pricing information for the life insurance plan to the user; send the additional display information to the client system receive quotes for the life insurance plan from a plurality of insurance carriers; and send the quotes to the user.

The invention also features a server that includes a processor, and memory, wherein the memory stores rules for underwriting life insurance, the rules comprising: a) basic rules, each basic rule applicable to a plurality of carriers; b) carrier-specific rules; and c) product-specific rules; and the processor is configured to underwrite life insurance using a user profile. The processor can be further configured to generate pricing information for a plurality of carriers based on the underwriting and send the pricing information to a client system. The rules can be organized in a hierarchy, and the processor can be configured such that basic rules are evaluated prior to carrier-specific rules and carrier-specific rules are evaluated prior to product-specific rules. At least some of the rules can independently determine if the user can be underwritten.

Aspects of the invention may include one or more of the following advantages.

The invention provides computer systems for processing and underwriting new applications for insurance over the Internet and/or using Internet-related technologies. The invention uses efficiencies provided by networked computer systems such as a system networked together by the Internet. The invention enables users to have life insurance policies evaluated by multiple insurance carriers in real-time. Individual users or intermediaries, such as licensed insurance agents, can provide the system information about the applicant's risk. The system assists and facilitates the evaluation of this risk against the underwriting criteria of multiple carriers to create the insurance policies.

An individual must consider many requirements such as lifestyle, needs, and future circumstances when selecting insurance coverage. In addition, he must educate himself on available products, and survey the vast market of insurance carriers in order to find the best-valued insurance product. Even, after such selections are made, the process of obtaining life insurance is complex and frequently requires multiple transactions, forms, and medical tests.

Aspects of the invention provide methods, software, and computer systems for selling life insurance to individual users and insurance agents. The invention streamlines the process of comparing multiple carriers by recommending an insurance plan tailored to an individual's circumstances and lifestyle. The invention further underwrites the plan with multiple carriers, allowing the individual to select the most desirable and economical plan based on the results of each carrier's underwriting decisions. The economical plan based on the results of each carrier's underwriting decisions. The invention further facilitates the process by scheduling medical exams and test, producing necessary forms and documents, and facilitating the sale for any selected carrier. The invention also has aspects that enable individual carriers to automatically provide these services for their users.

### BRIEF DESCRIPTION OF THE DRAWINGS

FIG. 1 depicts a schematic for an overall flow for selling life insurance.

FIG. 2 depicts a block diagram of a system for selling customized insurance and for providing insurance services.

FIG. 3 depicts a flow chart of a method for selling customized insurance.

FIG. 4 depicts a block diagram of an insurance provider network for selling customized insurance.

FIG. 5 depicts a flow chart of a method for suggesting an insurance step plan to a user.

FIG. 6 depicts a display of recommended insurance plans.

FIGS. 7A and 7B depicts structured rule sets for underwriting an insurance policy.

FIG. 8 depicts a flow chart of a method for finalizing and selling an insurance policy.

FIG. 9 depicts a graphical display of price range information for the sale of insurance policies.

FIG. 10 depicts a query process for obtaining a user profile.

FIG. 11 depicts a hierarchical process for querying a user.

FIG. 12 depicts a process for completing an electronic sale of a life insurance policy.

FIG. 13 depicts an exemplary computer system for implementing aspects of the invention.

### DETAILED DESCRIPTION

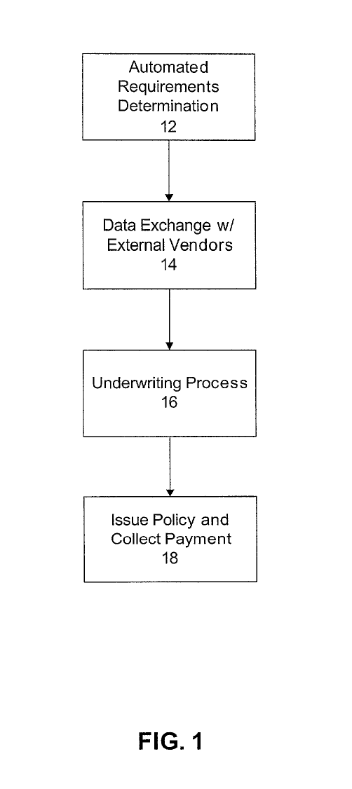

Referring to FIG. 1, an overall process 10 for selling life insurance across a network includes an automated determination of user requirements 12; electronic data exchange with external parties 14; an underwriting process 16; and issuance of a policy and payment collection 18. The process 10 interfaces with a user—who can be a customer or an agent, such as a licensed insurance agent—hereinafter, referred to as the “user.”

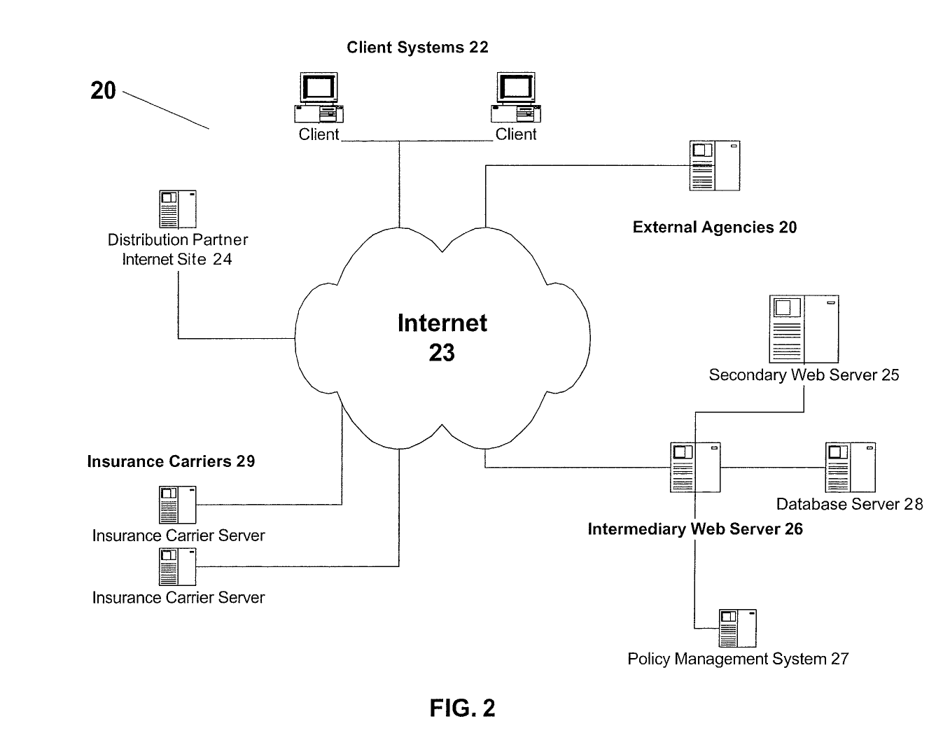

Referring to FIG. 2, a system 20 for selling customized insurance and for handling delivery of insurance services is shown. The system includes client systems 22 coupled via the Internet 23 to distribution partner sites 24 and an intermediary server system 26. The intermediary web server 26 is also networked to external agencies 27, and insurance carrier web servers 29. On an internal network, e.g., an intranet, the intermediary web server 26 can also be connected to a secondary web server 25, a policy management system 27, and a database server 28.

The client 22 can directly contact the intermediary web server 26, or may be redirected to the intermediary web server 26 by a partner distribution site 24. On entering the site, the user at client system 22 can logon and can be tracked using an identifier, e.g., a unique numeric ID. If the user at client system 22 does not log on, the user can still be assigned a unique numeric ID. The intermediary web server obtains a profile for the user. For new users, a profile can be collected over several screens, e.g., using hypertext forms with relevant questions. The data in the replies are saved in the user profile, e.g., on the local database server 28. For redirected users, the intermediary web server 26 can obtain the user profile from the distribution partner 24, e.g., a profile stored in a partner distribution database. Missing information from the supplied profile can be completed by querying the user. For returning users, the intermediary web server 26 can obtain the user profile from the local database server 28. In other embodiments of the system, the intermediary need not exist. Instead, the functions of the intermediary server 26 are accomplished by distribution partners insurance companies etc.

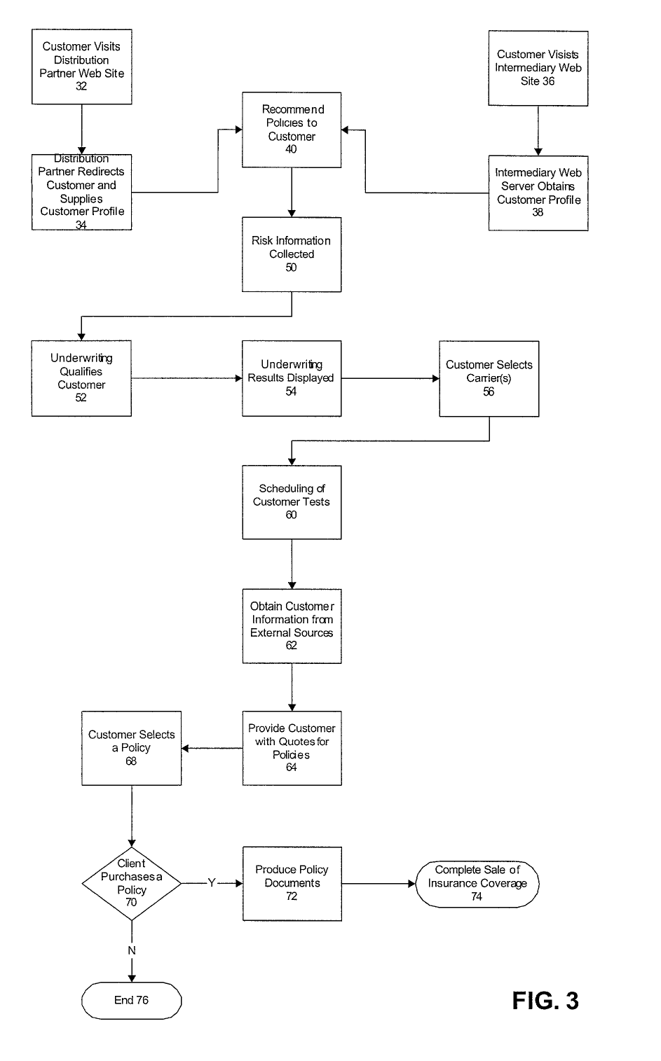

Referring now also to FIG. 3, a process 30 for selling a user insurance is shown. A user interested in purchasing insurance, e.g., life insurance, uses a web browser at one of the client systems 22 to access 32 an Internet site, e.g., one of the distribution partner Internet sites 24. The distribution partner Internet site 24 redirects 34 the user at client 22 to an intermediary web server 26. The redirection can be seamless; e.g., the web server provides content in the format of the distribution partner Internet site, e.g., the user at client system 22 need not be cognizant of the redirection. Alternatively, the user directly accesses 36 the web server 26.

The intermediary web server 26 obtains 34 a profile of the user from the distribution partner site 24 or directly 38 from the user. The profile can include: name, date of birth, gender, address, marital status, banking information, credit information and so forth.

The intermediary web server 26 stores user profiles, answers, and selections in a database server 28. The user profile is used to recommend 40 policies to the user based on results obtained from examination of the profile against underwriting policies or rules for multiple insurance carriers. Based on the user's profile, e.g., age, gender, marital status, dependents' age, occupation, income, and so forth, a recommendation engine (not shown) recommends 40 life insurance policies and life insurance carriers to the user. The user 12 can be provided with options to alter the plan and/or select subsets of insurance plans or insurance carriers. In some embodiments, the recommendation engine recommends a step plan as a preferred life insurance policy. Alternatively, the user 12 can interactively build his own insurance step plan, or other types of insurance coverage. Web pages are used to obtain user preferences and to guide the user through the process. Once a user at client system 22 selects a life insurance step plan, an underwriting engine (not shown) initiates processes to underwrite it.

Information about user risk is collected 50 from the user and any other sources of risk assessment. The questions can be directed to lifestyle, high-risk pastimes, and so forth. This information, as with all user information, can be directly requested from the user using hypertext forms and protocols. The user risk information is stored in the user profile. The profile, including risk information, is filtered 52 against insurance carrier rules for underwriting. The filtering process iterates over underwriting rules for multiple insurance carriers. If the user 12 is not excluded by the filter, the underwriting engine qualifies 52 the user 12 for underwriting. At this stage, the underwriting engine can also rate the user 12. The rating can be quantitative, such as a numerical parameter, or qualitative, e.g., the rating can be preferred, standard or sub-standard. The rating can be used, e.g., for providing an initial pricing range.

The results of the underwriting process can be displayed 54 to the user 50. The results are rendered as a graphical display of insurance risk relative to a general population. The user at client system 22 can also be provided with estimated costs for each select plan. The user at client system 22 can elect 56 a specific plan for coverage.

The purchasing process is finalized by obtaining additional information about the user 62, determining the price for the plan 64, producing electronic documents 72, and completing the sale 74.

Additional information about the user 12 is obtained 62 across the network from a variety of outside agencies 27, e.g., an industry database (e.g., the Medical Information Board (MIB), Westwood, Mass.), a motor vehicle registry, a law enforcement agency, a credit-rating agency, and so forth. The external agencies 27 reply 54 across the network with the requested user information.

In cases where obtaining information from an outside agency requires user participation, the web server can facilitate this process, e.g., by receiving authorization or scheduling from the user. For example, the web server can request 60 scheduling options from the user for user tests, e.g., medical or paramedic tests. After the user selects 60 an acceptable schedule option, the web server contacts paramedics at an external agency 27 to meet user at the scheduled time and obtain medical information from the user. The results from the appointment can be sent back 62 to a business-to-business server (not shown) via the Internet 13, e.g., by E-mail, hypertext web pages or hypertext forms and so forth. The results of paramedic visits, medical testing, and outside agency information are used to provide 64 a quote for insuring the user. For example, the combined data can be parameterized and applied to insurance carrier rule functions to generate a policy price.

The web server notifies the user of results of the testing and provides costs to the user for underwriting policies. Quotes can be provided 64 for more than one insurance carrier. The user selects 68 a policy and decides 70 whether to purchase the life insurance plan. The selection and purchase decision are transmitted over the Internet to the web server. In response, the web server supplies 72 electronic documents to the user. The documents can be generated by populating an electronic form (e.g., a PDF (portable document format) file) with information from the user profile.

Alternatively, the documents can be sent to the insured via mail and so forth. These electronic documents or the mailed documents, etc. constitute the insurance policy sold to the user. The user provides a payment and the intermediary web server 16 contacts an insurance carrier web server 22 of the completed policy. The insurance coverage sale is complete 74.

In some implementations, the intermediary web server 26 interacts with an insurance broker operating at a broker client system. The broker can operate on behalf of the user, e.g., as a proxy for the client system 12. The broker client system can provide the intermediary web server 26 with information about the user profile and so forth. For example, the broker client system can be connected to the intermediary web server 26 on an intranet. The broker client system can, if necessary, communicate with the client system, e.g., using the Internet, to relay information, such as quotes, approval, electronic signatures and documents.

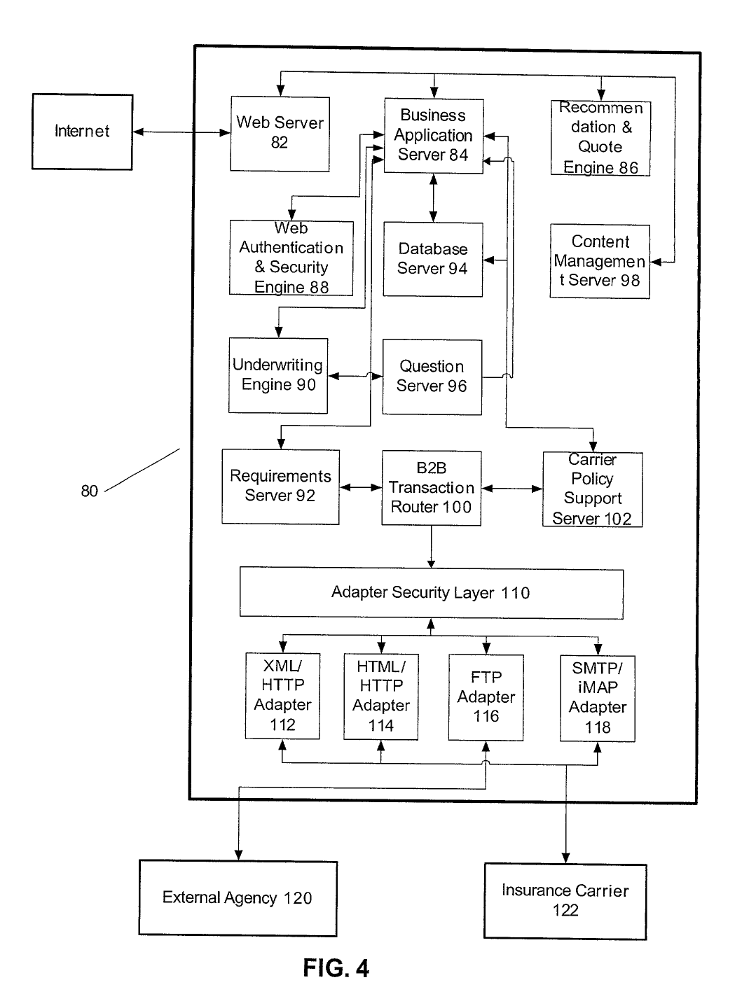

Referring to FIG. 4, a system 80 for executing portions of the insurance process 30 is shown. The system 80 includes a variety of servers and engines, which may be implemented as modules within one or more machines. The system includes modules that were mentioned but not referenced with respect to the discussion of the process of FIG. 3 such as the recommendation engine, underwriting engine and the business-to-business server. The system 80 includes an intermediary web server 82, that is coupled to the Internet 13 and which feeds information to a business application server 84. The business application server 84 hosts processes or engines to execute process 30. The business application server 84 includes, a recommendation and quote engine 86, a web authentication and security engine 88, an underwriting engine 90, a requirements server 92, a database server 94, a question server 96, a content management server 98, a business-to-business transaction router 100, a carrier policy support server 102, an adaptor security layer 110, and an exception handler 88. These engines or processes cooperate to execute the process 30 described above.

The adaptor security layer 110 provides secure communications with any external partner by sending data, e.g., encrypted XML, encrypted HTML, encrypted PDF etc., using a protocol, e.g., HTTP, HTTPS, WAP, SMTP, or FTP to interface across a network, e.g., a private channel frame relay, a dialup connection, or a TCP/IP network. The adaptor security layer 110 can include an XML/HTTP(s) adaptor 112, an HTML/HTTP(s) adaptor 114, an FTP adaptor 116, an SMTP/IMAP adaptor 118, and a proprietary adaptor 120 that can be used for establishing other communication channels using proprietary protocols. The adaptors can be connected to a workflow and logistics server 102 that is connected to systems used by insurance carriers 104 and external agencies 20.

The intermediary web server 82 can be connected to a client 22, e.g., a partner-originated client, a phone operator, an application administrator, an underwriter and so forth. These communications, e.g., with the user at client 22, can be made secure using the web authentication and security engine 88 which can execute login protocols, verify passwords, and encrypt content, e.g., using HTTPS protocols (e.g., including SSL), and other standards protocols.

The intermediary web server 82 communicates with a client 22, for example by sending web pages. Examples of formats for web pages include hypertext, HTML, XML, WAP, and PDF. The intermediary web server 82 provides such content based on instructions from a business application server 84. Likewise, information communicated to the intermediary web server 82 from the Internet is relayed to the business application server 84. The content management server 98 can customize web pages for delivery to a user. For example, the content management server 98 can produce web pages that have the appearance of a distribution partner web site 14.

The business application server 84 is connected to a question server 96. The question server 96 provides hypertext forms with questions and choices for the client 22. The user 12 replies with answers and selections through the intermediary web server 82. The question server 96 can verify each answer, e.g., to check that numerical fields are within acceptable ranges, and that text fields are completed, etc. In addition, the question server can provide a query and prepopulate the form with multiple choices for answers, such that the answers are relevant to the questions. The potential answers can be obtained from a database of acceptable or appropriate answers. Alternatively, the user's browser can verify answers prior to submission. On receipt, the answers are stored in a user profile in the database server 94. The question server can use a reflexive questioning process to query a user (see “Reflexive Questioning” below).

The underwriting engine 90 features methods for underwriting a life insurance policy based on a user profile and underwriting rules for a plurality of insurance carriers. The underwriting rules are obtained by the underwriting engine 90 from the business application server 84. The business application server 84 stores the underwriting rules for each carrier in a file, e.g., a XML file, or in the database server 94. The underwriting engine 90 determines the necessary queries in order to determine if a user profile is acceptable to a set of underwriting rules. These queries can be referred to the question server 96. Details of the underwriting process are also set forth below (see “Underwriting”, below). The underwriting rating produced in the first pass is referred to the policy recommendation engine 86.

The business application server 84 is coupled to the recommendation and quote engine 86. The recommendation and quote engine 86 assesses a user profile provided by the business application server 84 in order to determine user needs. The engine 86 produces a recommended life insurance policy for the user. The engine 86 can further provide a cost estimate or quote and a graphical display of user risk, e.g., a graph of a normal distribution of coverage cost or risk with a demarcation of the user coverage cost or risk relative to the distribution. See “Needs-Based Assessment,” below.

User selections are processed by the business application server 84 and routed to the appropriate server or engine. For example, selections provided by the recommendation and quote engine 86 are referred to the underwriting engine 90 in order to select an insurance carrier to underwrite a policy. Underwritten policies are relayed back to the business application server 84, which issues a request for coverage to the carrier policy support server 102.

The carrier policy support server 102 produces electronic documents to authenticate the policy, e.g., documents requiring a user's signature or a user's electronic signature, and can issue these through the business-to-business transaction server 100 to the appropriate insurance carrier 104. The communication between the business-to-business server 100 and the insurance carrier 104 can be made secure using the adaptor security layer 110 and various internet and network protocols, e.g., protocols accepted by an XML/HTTP(s) adapter 112, an HTML/HTTP(s) adaptor 114, an FTP adaptor 116, an SMTP/IMAP adaptor 118, and a proprietary adaptor 120.

The business-to-business transaction server 100 is also responsible for the management and automation of workflow for processing information exchange with external agencies. See “Logistics Management,” below.

Needs-Based Assessment

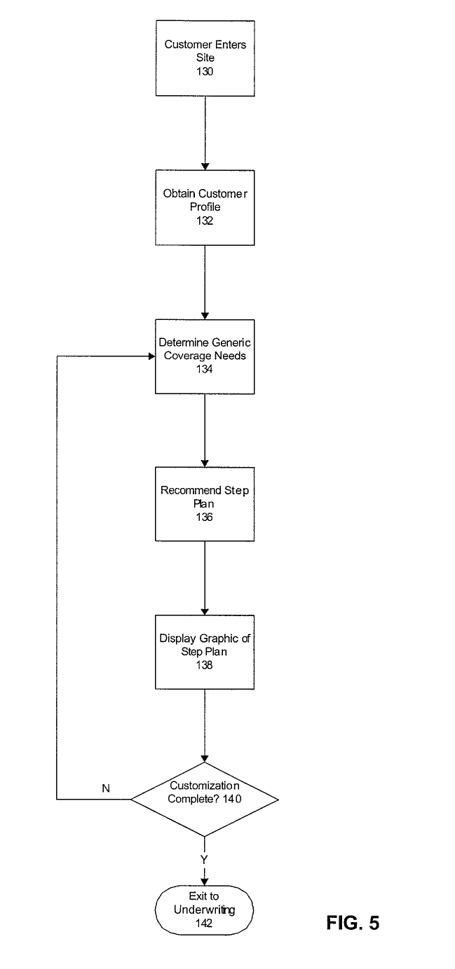

Referring to FIG. 5, a process for recommending a life insurance plan to a user is shown. The process includes a needs-based assessment. A user at client system 22 enters 130 a web site and the site obtains 132 the user's profile. The site uses the recommendation engine 86 to determine 134 the user's coverage needs. The recommendation engine 86 can suggest 136 a step plan that is graphically displayed 138 to the user at client system 22. The user at client system 22 can choose 140 to further customize the plan, e.g., by adjusting coverage needs 134, and optionally other assumptions. The user's input is used to update the step plan and its graphical display 136. Once the user accepts the customized plan 140, the system exits 142 the needs-based assessment process and can proceed, e.g., to underwriting.

The intermediary web server determines 134 the user's generic coverage needs by providing a high level questionnaire based on the user profile. The questionnaire relates to the user's coverage needs, e.g., lifestyle, marital status, dependents' age, dependents' living expenses, dependents' educational and/or employment status, and so forth.

In one implementation, the needs-based assessment queries the user at client system 22 for pertinent information. Such information includes the user's age, income and savings (including gross annual earned income, annual retirement savings, annual non-retirement savings, current non-retirement savings). The needs based assessment queries the user for expenses such as mortgage (including monthly payment for mortgage, years remaining for mortgage), projected higher education costs for each child (including age of each child, and projected number of years of postsecondary education for each child). Additional information that is obtained includes self-employment information (including current payables, long term loan balance, long term monthly payment, long term years remaining). The assessment can query for existing insurance coverage, e.g., current life insurance coverage (including current life insurance coverage, and remaining term of current insurance).

The system also factors certain assumptions including: planned retirement age, mortgage interest rate, business loan interest rate, annual inflation rate, present value discount rate, annual return on investments, average income tax rate, average capital gains tax rate, higher education costs, age to start higher education, funeral expenses, current personal debt, and time horizon years. These assumptions are used to determine a recommended level of coverage for the user for different time intervals. The default values for these variables can be determined based on the market (e.g., country of interest), time (e.g., prevailing market rates), and individual (e.g., tax bracket).

Prior to completing the needs assessment, the user at client system 22 can choose an appropriate scenario that best describes his/her situation. Exemplary situations include: (a) new parenthood, (b) new homeownership, (c) new marriage, (d) recent divorce, and (e) self-employment. Only information relating to each user's situation is collected. For example, self-employment questions are not asked of a user who is not self-employed.

If part of a user profile was previously obtained, e.g., from a previous interaction or from a partner's database of profiles, the questionnaire form can be populated with answers from the user profile, leaving the user at client system 22 only with questions for unknown parameters. The questionnaire can include several screens of forms, depending on the outcome of previous replies and the user profile. As the user at client system 22 completes each form, the server validates the response and updates the new information to the user profile.

Based on the user's profile and the answer to generic coverage questions, the recommendation engine 86 recommends 136 at least one insurance plan. Recommended plans can include various types of term insurance, or whole life insurance. In many instances the recommendation engine will recommend a step plan for life insurance, e.g., a policy with multiple steps, e.g., three to five or more steps.

In one exemplary implementation, process is used to provide a recommended step plan to a user at client system 22. The process uses formulas and graphing functions of the information entered by the user along with system variables. The formulae in each step of the step plan are evaluated for each time intervals in increments of, e.g., five years over the total time that the plan will be in existence. For example, if the needs assessment time horizon is twenty years in to the future, steps would be calculated for each five year interval: at 0, 5, 10, 15, and 20 years. The process can be implemented using a spreadsheet or any programming language.

The process starts by projecting the cost for a variety of needs. To project needs for paying off a mortgage, the amount of money needed in each specified time interval to put towards a mortgage is calculated. The process also includes a projected needs for self employed users, e.g., the amount of money needed in each specified time interval to pay off a long-term loan and to put towards debt associated with self-employment is calculated. Other features include projecting needs for the replacement of a base salary, e.g., the amount of money needed to replace the base salary and/or net income of a user over each specified time interval is calculated. The amount of money needed to cover transitional expenses such as funeral, auto loan, and credit cards costs incurred by the user can also be calculated for each specified time interval. The process then sums the projected needs to determine the total projected need for the each time interval.

The process continues by calculating education needs, e.g., the cost of each of the user's children's education. The cost can be based on tuition costs and corrected for inflation to the time when the child begins their postsecondary education. An additional factor is the cost of each child's current tuition. These costs are summed to determine the total education cost and projected for each specified time interval.

The process can also determine the total resources of a user. This includes calculating the value of existing non-retirement savings and the value of existing life insurance coverage over each specified time interval. The process evaluates the amount of life insurance required by accounting for current non-retirement savings and the total need of the user for each particular time interval. The recommended amount of life insurance can be determined by averaging or smoothing the required amount for each of the time intervals. The recommended step plan is displayed 138 as a graphic, e.g., a graph depicting value of coverage on the y-axis and time in the future on the x-axis.

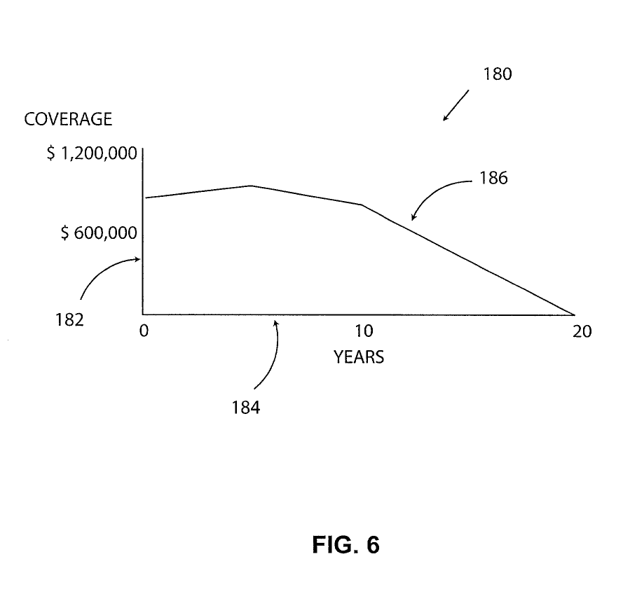

Referring now also to FIG. 6, a two-dimensional chart 180 is plotted, with insurance policy amount coverage on the y-axis 182 and time intervals over the time horizon, in this case twenty years (in five year increments), on the x-axis 184. The data points for each time interval are calculated from the result of the formula used to determine the Life Insurance Needed. That is, the amount of life insurance required to account for current non-retirement savings and total need in a particular time interval. The data points can be used to plot a line 186 which indicates changing coverage over time, e.g., as recommended based on a user's changing needs. For example, coverage can begin at $850,000, increase to $900,000 over 5 years, decrease to $800,000 over the next five years, and then decline to $0 over the final ten years. Another feature of the plot can be an overlapping illustration of required, recommended, and existing life insurance coverage (not shown).

Referring back to FIG. 5, the user at client system 22 can either elect 140 to provide additional customization, e.g., by answering additional questions regarding coverage needs or by modifying answers to previous questions. In addition, the user at client system 22 can modify parameters for modeling the plan, e.g., the user at client system 22 can modify the interest rate. This process can continue until the user at client system 22 accepts a recommended step plan. Then, the system initiates a process to underwrite the accepted step plan.

Underwriting Process

After a recommended plan, e.g., a step plan, is selected, the system can underwrite the plan using a multi-pass process. Underwriting is a determination of the risk associated with insuring a particular user. This feature involves an automated underwriting system that interacts with a declarative rules processor that encapsulates hierarchical underwriting rule sets for multiple insurance carriers. The system can automatically produce underwriting ratings based on responses to a user profile.

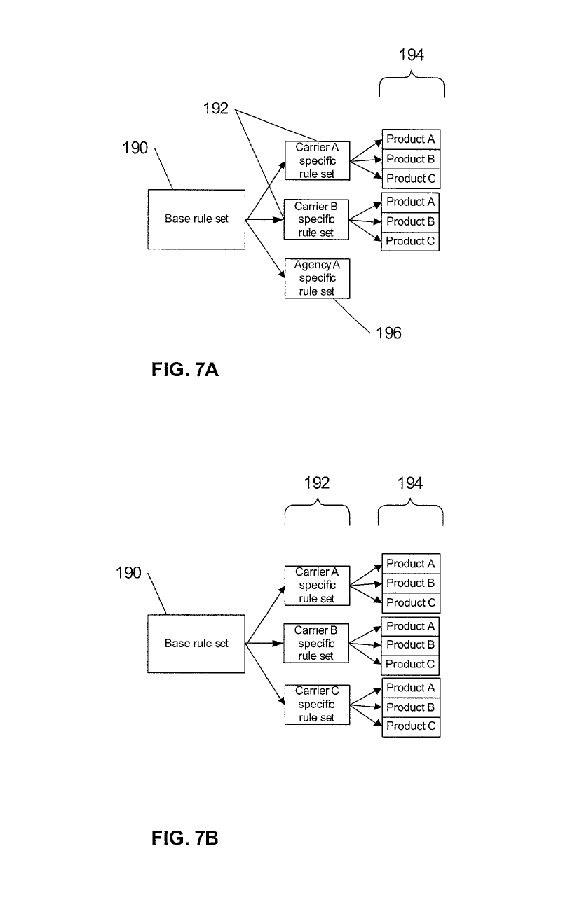

Underwriting Rules. The underwriting engine 90 is programmed using a set of rules as shown in FIGS. 7A and 7B that are developed in consultation with term life insurance underwriters and so forth. These rules capture manual term life insurance underwriter's rules and automate the insurance underwriting process using decision trees and enable the system to generate a rating and pricing information for a particular user without the need for human intervention.

As shown in FIGS. 7A-7B, the rules are structured in a hierarchal manner to include basic underwriting rules 190 (e.g., applicable for all carriers and products), rules specific to individual carriers 192, and rules specific to individual products of each carrier 194. Hence, the system supports the simultaneous underwriting of a user's profile against multiple carriers and multiple products.

The rules can include rules 196 that generate requirement events (i.e., obtaining additional information from a user or third party provider such as an external agency) and rules that determine pricing estimates and quotations (also termed, “assessment and classification rules”). The rules can be parameterized so that values from a user profile can be compared against the rule. In particular, many pricing rules are parameterized in order to price risk in the determination of a premium, i.e., the rules can contain business information.

If the system were to receive underwriting information from a user that cannot be processed by the rules in the underwriting engine (e.g., the user enters a rare disease not recognized by the underwriting engine), an exception is created, and the client's account is referred for manual processing. Alternatively, a new rule is manually or automatically constructed to handle the exception. As new rules are added to the rules sets, the rule sets become more comprehensive over time.

In one implementation, the underwriting rule engine 90 is used to process the rule set. Information about a user is passed to the rule engine. For example, attributes for cholesterol blood levels, age and sex can be retrieved from a user profile and compared against rules to classify the user at client system 22 for a particular policy.

In one particular implementation, the rule engine is stateless. This design facilitates a multi-pass analysis wherein a case is underwritten over multiple sessions as data is available. As new information is received, the rule engine re-evaluates the user's profile against all the rules.

The underwriting decision engine can determine an underwriting score using a debit scoring system. Points are added as negative findings, e.g., risk-sensitive activities, medical problems, credit history, fraud problems, are encountered. For example, slightly elevated cholesterol might be only +50 debits, still within the Standard classification but high blood pressure adds another +50, and +100 debits puts the applicant now in a substandard class.

Multi-Stage Underwriting Process.

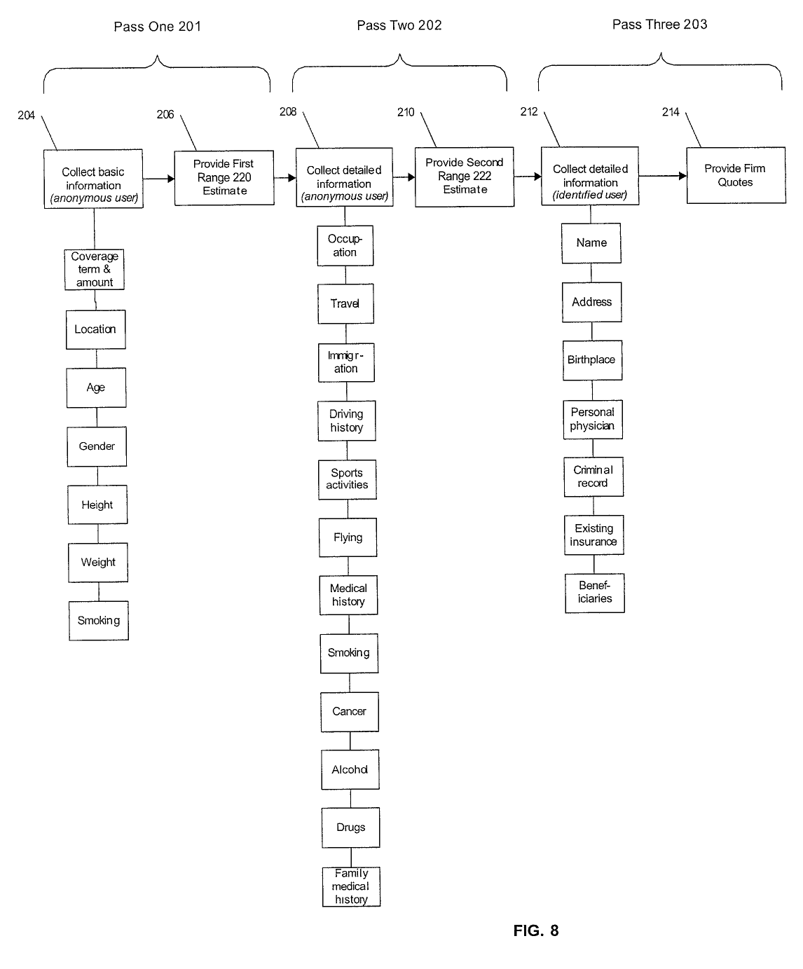

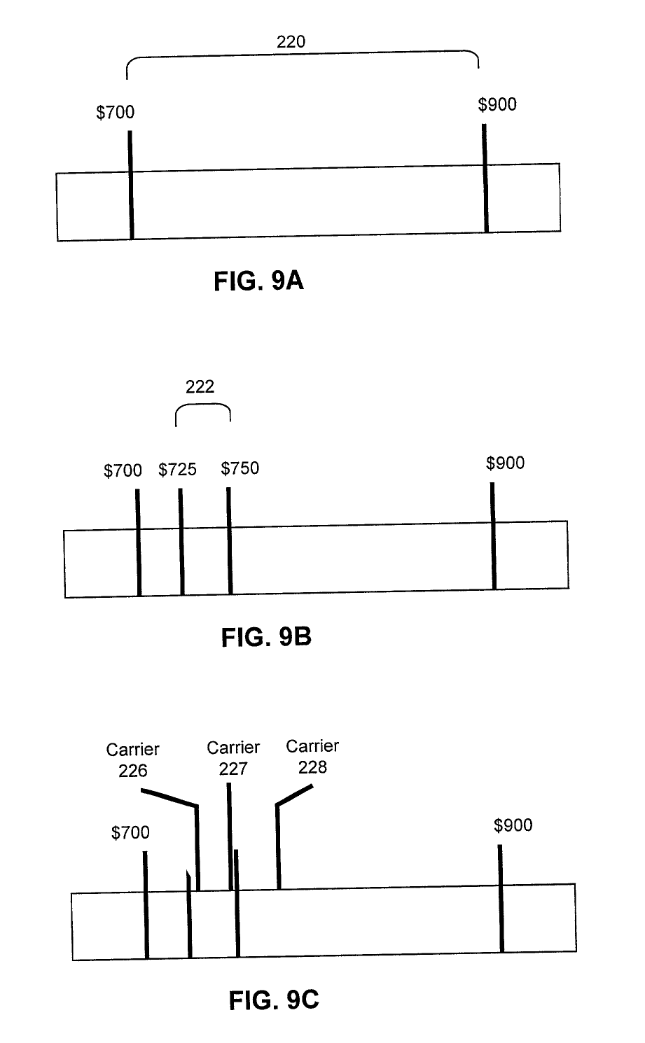

As shown in FIG. 8, the insurance system features a multi-stage underwriting process. This multi-stage process can also be integrated with a reflexive questions process in order to progressively provide life insurance premium cost information to the user at client system 22. Advantageously, the user at client system 22 is only required to enter minimal information at the outset. As the user is advised on a broad quote range, the user is given the option to provide additional information for more refined quotes. This approach is particularly suited to a typical user's non-committal initial interaction with Internet web sites. Each quote or range of quotes can be displayed graphically, e.g., as depicted in FIGS. 9A, 9B, and 9C.

Referring both to FIGS. 8 and 9A, B, C, in the first stage 201, the user profile is rated against the rules, typically, rules from multiple carriers. The rating can provide an initial price range 220 for the selected insurance plan. In the second stage 202\ more detailed information on the user is taken into account to generate in a more refined (narrower) range 222. The third stage 203 involves receiving binding offers (226, 227, 228) from insurance carriers, i.e., exact prices for the selected insurance plan.

Stage 1—Initial quote range estimation. In Stage One 201, the initial range estimate 220 is obtained by considering the desired coverage term and amount, and by collecting basic information 204, e.g., information about the user's location, age, gender, height, weight, and smoker status. Because multiple carriers are represented in the rate table, a group of rates is returned. The lowest and highest rates in this group define the range. The quote range 220 is presented 206 to the user as the total purchase amount—i.e., it is calculated by considering the rate with the amount of insurance specified or by comparison to others having a similar profile as the users.

The user can remain anonymous during this stage, meaning that they are not required to submit any information that would reveal their identity or address. Alternatively, the initial quote can be based on the user profile. For example, the user profile and risk status are initially filtered against a simplified rule set to determine if the user is generally acceptable. The underwriting engine 90 then rates a user at client system 22 as “super-preferred, preferred, standard, sub-standard, or denied.”

This rating is then used to look up pricing information from a database rate table (Table 1).

TABLE 1

| Attribute | Description |
|---|---|
| Carrier ID | Identifies the insurance carrier providing this rate. |
| Age | Age of user. Valid range is 20-75. |
| Gender | Gender of user, male or female. |
| Smoker status | Smoker or non-smoker. A smoker is defined as one |
| | who has smoked one or more cigarettes in |
| | the past 12 months. |
| Classification | Super-preferred, preferred, standard, or rejected. |
| Rate | Annual rate in dollars per $1,000 of coverage. |

In one alternative embodiment, the user's risk is displayed as a graph that indicates the risk of the user, e.g., the carriers' perceived risk of the user. This risk is plotted relative to a distribution, which represents the risk of the general population. The distribution can be generated from data on the normal population, or from actuarial statistics. Alternatively, the distribution can be generated by a function, e.g., the Poisson function. The graph can be generated by the server and sent to the user's web browser as an image file. The user can communicate with the server to modify 160 parameters, e.g., interest rate, and thereby modify the graphical display. In another implementation, the server transmits to the user an instruction set, e.g., a Java program or applet. The instruction set generates the graphical display based on parameters that the user can adjust, as well as parameters supplied by the server.

Stage 2—Refined quote range estimation. Referring again to FIG. 8, the broad price model provided by Stage One 201 is refined in Stage Two 202 by obtaining additional information 208 from the user, e.g., during the same or a subsequent web session. Information can also be obtained from other providers (e.g., laboratory results), as appropriate.

The quote is refined by deriving a classification for the user, and the rate is then looked up in the same manner as Stage One 201. Rate variability is dependent on the presence of multiple carriers in the rate table. Classifications are derived from underwriting, which is the process of assigning risk to a user. At this stage, underwriting takes into consideration, for example, the user's age, height, weight, tobacco use, alcohol use, medical conditions, family medical history, driving record, criminal record, travel, occupation, and recreational activities. If additional information is required, the reflexive question process can be used to obtain more information from the user at client system 22 and the logistics management system can be used to obtain more information from external agencies.

The underwriting process can be performed automatically or manually. If the underwriting classification is not “rejected,” the rate table is used once more to collect another group of rates. This range will be narrower due to the consideration of classification in the rate table. The lowest and highest rates in this group define the refined range.

Referring now to FIG. 9B, a refined range 222 of cost estimates is graphed.

Stage 3—Receive binding offers. Referring again to FIG. 8, for anonymous user, detailed information about the user's identity is collected 212. The information can include information about the user's name, address, birthplace, personal physician, criminal record, existing insurance, and beneficiaries. The application is forwarded to several insurance carriers of the user's choosing in order to receive firm binding offers 214. Underwriters (either human or machine) from multiple insurance companies can review the application and submit binding offers based on all available information, including the user's profile and any test results or additional reports.

Referring now to FIG. 9C, binding offers returned from insurance carriers are plotted, e.g., by overlaying the offers on the previous plot. The binding offers are shown with vertical lines 226 227 228 and are labeled with a unique alphabetic character for each carrier or for each product (A, B, C, etc.) with their respective prices. Binding offers may or may not fall within the shaded region. The resulting plot allows the user to graphically view the variation in quotes from multiple insurance companies. The user can be further aided by a legend that indicates the correspondence between carriers or products and lines indicating offered pricings.

As a result of the multi-step process and the multiple rules, the system determines and provides a range of quotes, based on rates from potentially several products from multiple insurance carriers. These quotes can include a calculation of the class, premium, and surcharge for the coverage.

Reflexive Questioning

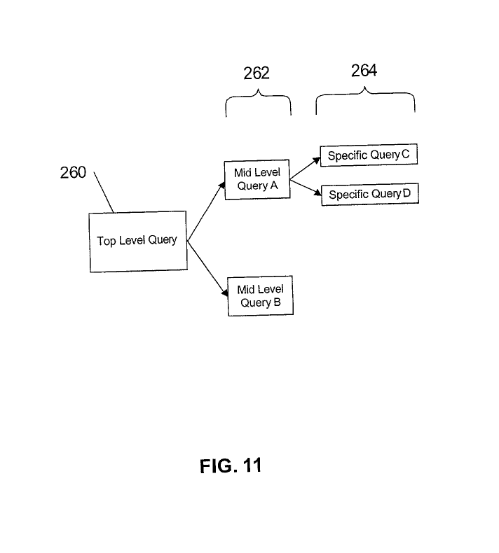

Referring to FIG. 11, the underwritten insurance application system employs a reflexive question engine 96 that serves questions to the user and analyzes their responses. There is logic built into the engine that only requires the user to complete the minimum number of questions required for the products and carriers being applied to for their given legislative jurisdiction (i.e. State, Province, or Country).

The question server 96 uses queries that are ordered based on responses to earlier queries to enhance the efficiency of the questioning process. The queries can be stored in decision trees and/or matrices to reflect this relationship.

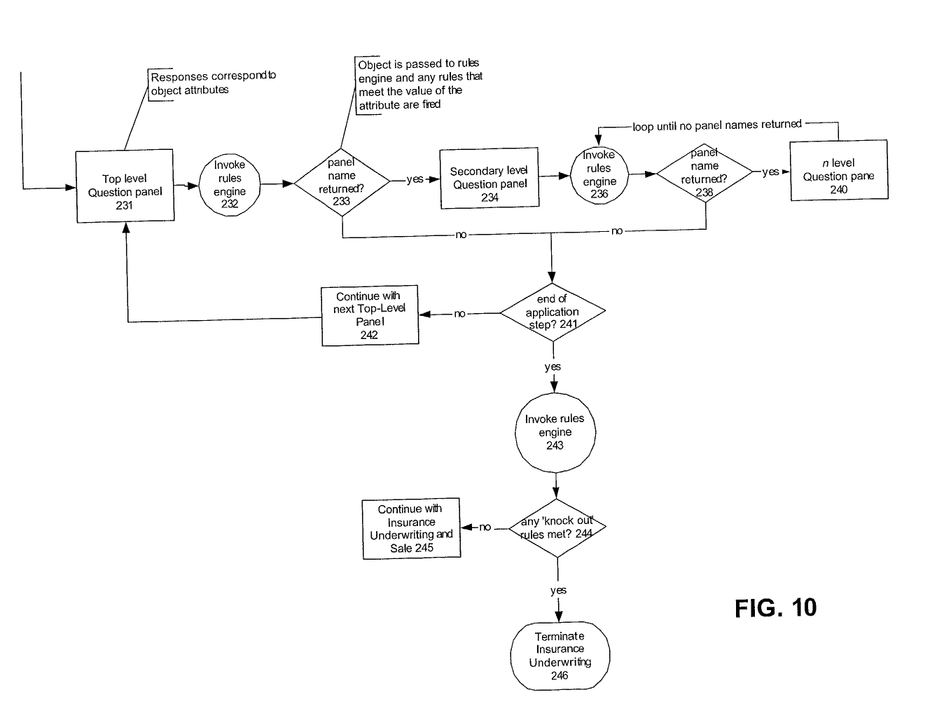

Referring to FIGS. 10 and 11, the query tree architecture includes multiple levels of query panels 260 262 264. The process for evaluating the tree architecture includes “drilling-down” from the top-level query panel to lower level panels. First, a top-level query panel 260 is used to pose 231 questions to the user. The process of drilling down is parameter driven, if a particular response matches defined parameters, then the question engine returns the name of a secondary query panel 262. If a panel name is returned 233, then questions from the secondary query panel 262 are posed 234 to the user. The responses to the secondary query panel 262 are evaluated using the rules engine 236, as before. If even more detailed queries are required 238, the process loops 240 through a tertiary query panel 264 and so on.

If no secondary panel name is returned, at 233 or 238, the tree determines if the application process has reached the end 241, i.e., if all the top-level queries 260 have been posed. If there are additional top-level queries 260, then the process continues with the next top-level query 242. If all the top-level queries 260 have been posed, then the rules engine is again invoked 243 to determine if any knock out rules have been met 244.

The tree architecture allows the system to customize the questioning process for each user. For example, a user response can cause certain questions to become irrelevant. Such a relationship between a response and subsequent questions are implemented as a rule in the rule set. The tree architecture, which interprets such rules, insures that the irrelevant questions are not presented to the user. Conversely, some user responses necessitate the collection of additional information, in the form of supplementary questions. Such supplementary questions can be placed in a branch of the decision tree. The response that necessitates the supplementary questions can be interpreted by the rule set to initiate the appropriate branch.

The order of the queries is also designed to obtain information that approves or excludes a user as early as possible in the questioning process. For example, instead of drilling down to a new panel, the response could signal an end to the process resulting in the user being “knocked out” of the process.

During the process, each response is stored and matched against a rule set, e.g., a decision tree, to determine the requirement and/or substance for subsequent questions. Each node of the decision tree can feature a question from a question set. The question set is compiled and designed from the base question set for each of the multiple carriers. The decision tree can also allow for differences in the questions required for different products from the same carrier by selecting only branches appropriate to the products under consideration. Similarly, the decision tree can accommodate the residential location of the user in order to provide questions apropos to the province, state, district or country of residence.

Implementation of the decision tree is flexible. Hence, rules can always be added, edited, deleted, or re-ordered as requirements dictate. This allows a question set to capture the required information for multiple carriers, e.g., all available carriers, and governmental agencies.

In some implementations, the use of free-formed text is minimized by prepopulate context-sensitive information into the forms where possible. Where information is collected as free-form text, an error detection protocol is applied to analyze the answer, e.g., by comparing the answer against a database of known acceptable answers.

All of these responses, entered via any method of entering information into a computer system, can be saved and revisited. A single response can be used to populate several insurance carriers' forms or data feeds for a carrier. The user therefore needs only to enter their information once, resulting in several insurance applications being filled out. The completed forms can exist electronically, or they can be printed out and handled in the traditional manner. This process also covers any supplementary forms or governmental forms to be included in the final application. Thus, the process streamlines the collection of information required for numerous forms of different carriers, and substitutes for the manual, and possibly repetitive entry of information into paper forms.

Personalization. The questioning process is personalized for each user, e.g., based on a user's medical history, activities, occupation, criminal record, family health history, and geographical location. For example, the same question can be presented to different users using different vocabulary or language in order to obtain the appropriate value for a variable field. If more information is required, drilldown questions are presented to the user.

Carrier specific requirements. At the outset of the application process, the user is able to select from the list of available insurance carriers those that they would like to apply with. Questions are customized to account for the differences in question sets from carriers that have been selected for consideration. For example, if a particular insurance carrier chosen by the applicant requires more detailed information on a certain topic, the reflexive question engine presents the additional questions during the application process.

Product specific requirements. Carriers may also offer multiple products (life insurance plans) to the user. Different plans have different requirements, and these requirements can also be collected by questions served up during the application process.

Local requirements. The geographic location of the user may invoke additional or different requirements from the carrier, a governmental agency, local laws, or local marketing information. For example, carriers may require more information if a user resides in a certain country, region, or city to determine their eligibility for insurance. There are also several differing regulations governing insurance policies depending on the jurisdiction. The reflexive question engine can serve questions to gather such requirements.

The rule set for each topic is evaluated in a hierarchical manner that allows for ordered processing of responses and that accounts for as many additional or specialized requirements that may exist. The questions associated with each topic are ordered as question panels or so-called “drilldown panels.” The first level drilldown panel collects basic information about a topic. The rules engine determines the relevance of subsequent panels (hence the name reflexive question engine). For example, if the smoking attribute on the first level panel is true, the rules engine returns the panel name of the second level panel for smoking. Second and subsequent level drilldowns will contain questions that serve to collect increasing detail. For example, at the second level, details required by particular insurance carriers or governmental agencies can be obtained. At a third level, details required by a particular product can be obtained. The number of drilldowns is unrestricted. When no further drilldowns are required, the first level panel of the next topic is presented. At the final topic within a step, the rules engine can invoke a knockout rule.

Knockout rules are processed at particular points 244 in the application process and determine if the user has entered any information that makes them ineligible for life insurance. The criteria for ineligibility may be based on any number of reasons. For example, the user may represent an unacceptable risk based on their financial situation, physical build, medical conditions, or participation in risky activities. If none of the knock out rules is met, the application and insurance process continues 245, e.g., with the submission of associated reports to the underwriting engine 90.

Rules can be modified or added at any time using an editor interface.

Logistics Management

The system also features an automated internet-based logistics management system. The system automates the back-end processes that follow from a user completing an online application. The back-end processes include: 1) data exchange with external agencies and carriers, 2) policy issuance; and 3) payment collection. Advantageously, these automated processes reduce the number of paper transactions and the delays incumbent on the use of paper media. During the entire process, the system tracks all events and forecasts future events based on past averages, and handles exceptions or errors that may occur during the process. The user and company service staff can log in to the system at any time to view the status of an application.

Automated requirements determination. A requirements engine determines what additional information is required to assess the risk of the user at client system 22 for the carriers under consideration. The engine has rule sets that are invoked to process the insurance application. Depending on the criteria, individual carriers may require different reports. Individual insurance products may also require specialized requirements. The rule set will process the user's application responses and generate a unique set of data requirements for all carriers and products.

Following completion of the online application, the user selects one or more insurance carriers to provide quotes. The application and user's selections are transmitted to the requirements engine. Rule sets within the engine process the data provided by the user and determine what additional information is required to assess the risk associated with insuring this individual. A set of requirements is returned for each carrier selected for inclusion. The unique union of all of these sets is determined to ensure that only one copy of the same report is ordered.

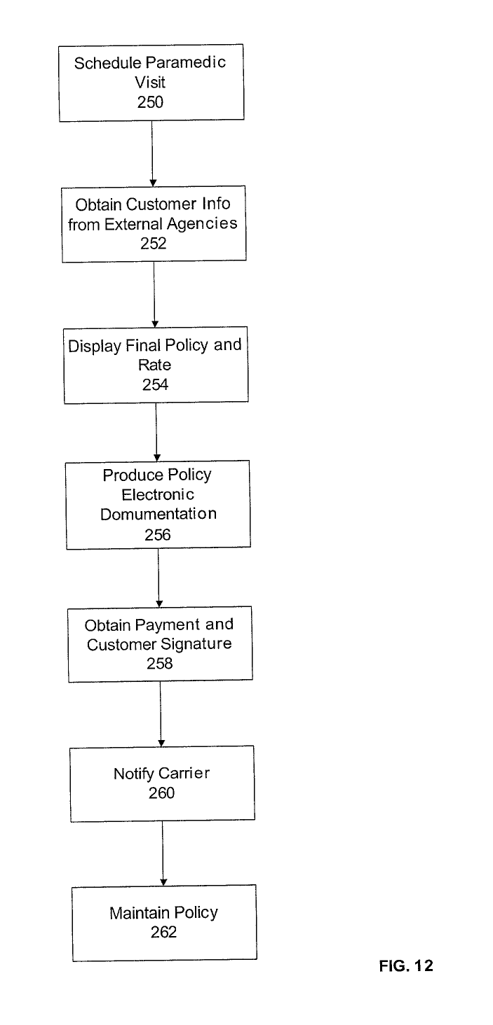

Data exchange with external agencies. Referring to FIG. 12, in the next phase of the application process, a paramedic visit is scheduled 250 with the user to obtain a medical report. The system also obtains 252 user information as necessary from external agencies to provide any of the following: (a) life insurance client application information, (b) doctor's or nurses visits or statements, (c) medical tests or sample collection, (d) motor vehicle reports (e) reports from labs (f) attending physician statements (g) other medical test information.

The requirements are requested electronically from the appropriate third party vendors. Vendors might include a medical information database, the motor vehicle reporting agencies, the user's personal physician, or a paramedical agency. The system is capable of exchanging data bi-directionally with any potential vendor using a wide array of electronic communication formats and transport mechanisms.

The requests are then transmitted electronically to the vendors. For medically underwritten insurance, vendors might include a medical information database, the motor vehicle reporting agencies, the user's personal physician, or a paramedical agency. Data exchange to and from the vendors can be performed using a number of electronic transport mechanisms including file transfer protocol (FTP), email, secure hypertext transfer protocol (HTTPS), or asynchronous message queuing. Generally, the data exchange is encrypted.

For example, the system can request times from the user for scheduling a paramedic visit. The business-to-business server 100 can contact the paramedic to schedule the visit. The paramedic visits the user to perform a routine medical exam, and, if necessary, to obtain fluid samples for testing. The fluid samples are processed, and the results are uploaded the results to the server, e.g., using a web form, email or other protocol. The server updates the user profile with the results.

The business-to-business server also obtains user information from external agencies, e.g. motor vehicles registries, credit rating agencies, and so forth. For example, the business-to-business server can communicate with the MIB (Medical Insurance Bureau, Westwood, Mass.) database. The mode of communication can be in batch mode, e.g., many records are requested at once, or in real time. In order to access a user's MIB record, the web server displays a Pre-Notice and MIB Authorization for user approval. Following authorization, the business-to-business server requests the MIB record for the user.

Since the lab tests, the paramedic scheduling, and the procurement of information from external agencies are all executed concurrently, the system continuously monitors the scheduling process for delays and exceptions.

The results of the paramedic visit and the information from external agencies are processed with the user profile and previously obtained information about user coverage needs and user risk in order to display a final policy and to determine costs for coverage. The user can be notified, e.g., by electronic mail, that the final recommendations and quoted prices are available.

Issue policy and payment collection. The end result of the underwriting process is the calculation amount requested by the user. Each carrier selected for consideration issues binding offers to the applicant. The logistics management system alerts the user each time an offer is received from a carrier. In addition, weekly updates are sent to the user to update them on the status of their application. The user may at any time log in to the system to view the current status of their application.

The user can choose to accept a quote from the carriers who have responded and make a payment, at which time a policy is generated. The policy and application are sent to the user to be signed. The policy and application can be sent as an electronic document, e.g., to be printed by the user, or to be electronically archived by the user. In some implementations, the electronic document can be signed electronically, e.g., using a customized or standardized electronic authentication protocol. Alternatively, the policy and application can be sent as paper documents by conventional delivery methods. The user can sign the paper document, and return it. When the signed application is received, the payment is processed and the policy is then in force.

Automatic event tracking and alerts. All of this information is transferred back to the system. The system automatically tracks events and handles exceptions, e.g., by generating alerts for human intervention. Standard times for completion are used to identify exceptions. These time thresholds can be dynamically generated from averages of real-time processing durations by the external agencies. For example, the thresholds can be set as the average time plus a constant. When all requirements are received, the application is sent for underwriting. If manual intervention is required during the underwriting process, the system manages the process with the underwriter.

The system monitors the application processing system and tracks all events, including requests, receipts, and inquiries. In addition, automatic alerts can be programmed to fire after certain criteria are satisfied. For example, when a carrier has submitted a binding offer, an alert will be generated resulting in an email to the user that informs him of the offer. Alerts may also provide notification that human intervention is required if the automated system encounters an exception. For example, an alert may be generated if a certain amount of time has elapsed with no forward movement on the application.

Because the system automatically records the date and time requests for data are sent and when the data is returned, it is possible to forecast future events by averaging past durations. These estimates can be offered to the user so they have a better idea of what to expect during the processing period. Alerts can be associated with these event forecasts so that if time has elapsed for an expected event, an alert can be generated to notify the responsible system or individual.

The logistics management system monitors the timing of the requests for information and when results are returned to the system. Forecasted events are presented to the user based on the averages of recent durations for similar requests.

Upon receipt of the reports, the rules engine is once again invoked to process the results, e.g., using Pass 3 of the Underwriting Process. A special set of rules, called knock out rules, will determine if any of the results render the user ineligible for life insurance coverage.

Document Management

After reviewing all of the offers, the user selects one and submits payment for the first month's policy premium. When the payment has been received, the in force record is sent to the selected carrier, and the carrier returns a policy and application. The application is filled in automatically using the information submitted by the user during the online application process. The completed policy and application are sent to the user, who then signs and returns them. The payment is then processed and the policy is in force.

Referring again to FIG. 12, an electronic policy document is produced 256 for select finalized coverage policies. The document can be a form required by an insurance carrier. The form can be completed using information stored in the user profile, or by querying the user. In particular, the system obtains in advance the required forms and documents for each insurance carrier. The user profiling process is designed to obtain all the necessary information to complete all the forms. Thus, after the user purchases a policy, the user profile is rapidly mapped onto the form of the selected insurance carrier.

The form or document can be an electronic document, e.g., a PDF (Portable Document Format, Adobe Systems, Calif.) file, that is sent to the user electronically, or it can printed on paper and mailed conventionally. The user can returned the signed document, e.g., using a legal electronic authentication method or using a conventional signature on paper. After the document is signed and payment is received 258, the insurance carrier is notified 260. During the term of coverage, the policy is also maintained 262, e.g., by updating the user profile, obtaining payments, and, if necessary, distributing the death benefit.

Additional processes are available specifically for new users. New users visiting the web site are offered temporary life insurance coverage. An initial user profile can first be obtained to determine if temporary coverage is recommended. For example, a user who has just had a child may desire immediate coverage. The system can identify users likely to require temporary coverage and alert them. Alternatively, the option for temporary coverage can be offered to all users. If a user elects temporary coverage, an online purchase transaction is made and the system creates a policy underwritten by an insurance carrier. For example, the policy can be valid from the date of purchase to a date 3-6 weeks later, or a date based on the average time required to complete the process of purchasing permanent coverage.

The invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits).

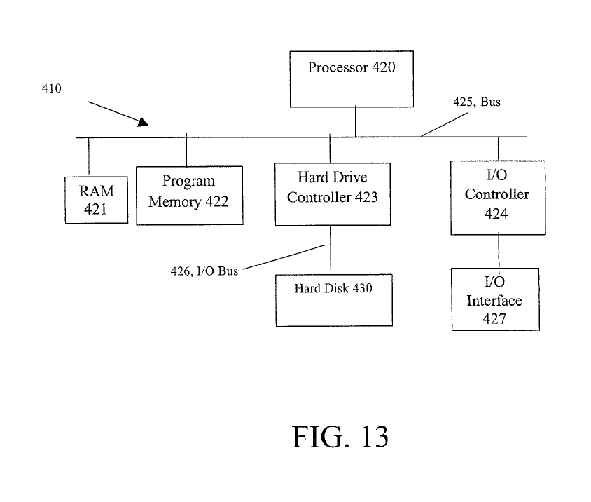

An example of one such type of computer is shown in FIG. 13, which shows a block diagram of a programmable processing system (system) 410 suitable for implementing or performing the apparatus or methods of the invention. The system 410 includes a processor 420, a random access memory (RAM) 421, a program memory 422 (for example, a writable read-only memory (ROM) such as a flash ROM), a hard drive controller 423, and an input/output (I/O) controller 424 coupled by a processor (CPU) bus 425. The system 410 can be preprogrammed, in ROM, for example, or it can be programmed (and reprogrammed) by loading a program from another source (for example, from a floppy disk, a CD-ROM, or another computer).

The hard drive controller 423 is coupled to a hard disk 430 suitable for storing executable computer programs, including programs embodying the present invention, and data including storage. The I/O controller 424 is coupled by means of an I/O bus 426 to an I/O interface 427. The I/O interface 427 receives and transmits data in analog or digital form over communication links such as a serial link, local area network, wireless link, and parallel link.

One non-limiting example of an execution environment includes computers running Windows NT 4.0 (Microsoft) or better or Solaris 2.6 or better (Sun Microsystems) operating systems. Browsers can be Microsoft Internet Explorer version 4.0 or greater or Netscape Navigator or Communicator version 4.0 or greater. Computers for databases and administration servers can include Windows NT 4.0 with a 400 MHz Pentium II (Intel) processor or equivalent using 256 MB memory and 9 GB SCSI drive. Alternatively, a Solaris 2.6 Ultra 10 (400 Mhz) with 256 MB memory and 9 GB SCSI drive can be used. Other environments could of course be used.

Other embodiments are within the following claims.

What is claimed:

1. A method comprising:
receiving a first set of information about a user;
displaying a first range of pricing information for a life insurance plan for the user to the user;
receiving a second set of information about the user;
displaying a second range of pricing information for the life insurance plan to the user;
receiving quotes for the life insurance plan from a plurality of insurance carriers; and
displaying the quotes to the user.

2. The method of claim 1 wherein the first set of information comprises information about gender, age, and tobacco use.

3. The method of claim 2 wherein the first set of information consists of no more than five fields.

4. The method of claim 2 wherein the first set of information consists of information about gender, age, and tobacco use.

5. The method of claim 1 wherein the first and second range are displayed as text.

6. The method of claim 1 wherein the first and second range are displayed as a graph.

7. The method of claim 6 wherein the quotes are displayed as locations on the graph of the second range.

8. The method of claim 1 wherein the second set of information comprises one or more of: height, weight, medical condition, family medical history, driving record, criminal record, and recreational activities.

9. The method of claim 1 further comprising receiving a third set of information after displaying the second range of pricing information.

10. The method of claim 9 wherein the third set of information comprises information about user identity.

11. The method of claim 10 wherein the first set of information does not indicate the user's identity.

12. The method of claim 9 wherein the second set of information comprises information about the user from an external agency.

13. The method of claim 9 wherein the second set of information comprises information about the user from a medical examination.

14. The method of claim 1 wherein the first and second set of information are received from the Internet.

15. The method of claim 1 wherein the displaying of the first and second range comprises sending display information across the Internet and rendering the display information in a browser.

16. The method of claim 1 wherein the displaying of the first and second range comprises sending display information across the Internet and rendering the display information in an electronic message.

17. The method of claim 1 wherein the first set of information is evaluated by querying a database of rates for a plurality of insurance carriers.

18. The method of claim 1 further comprising sending a series of questions to the user prior to receiving the second set of information, wherein responses to at least some of the questions in the series determine at least some other questions in the series.

19. The method of claim 18 wherein at least one of the questions in the series determines if the user is ineligible for each of a plurality of insurance carriers.

20. The method of claim 1 wherein at least the first set of information is received from a party other than the user.

21. The method of claim 9 wherein the first, second, and third sets of information are sufficient to obtain quotes for life insurance from a plurality of insurance carriers.

22. A machine-based method of underwriting a life insurance policy for a user comprising:
obtaining a user profile;
producing a rating for a user profile for each of a plurality of carriers;
recommending to the user a first subset of carriers which produce a satisfactory or better rating;
obtaining a second subset of carriers which are the user's selection from the first subset of carriers;
accepting a user for underwriting by each of the second subset of carriers by filtering the user profile against a first plurality of rules of the carrier.

23. The method of claim 22 wherein producing a rating comprises evaluating the user profile against a second plurality of rules that includes basic rules and carrier-specific rules.

24. The method of claim 22 further comprising displaying a range of pricings for the life insurance policy to the user.

25. The method of claim 22 wherein the user profile is obtained using the Internet.

26. The method of claim 22 further comprising identifying information required from external providers to underwrite the life insurance policy, and automatically communicating with the external providers to obtain the required information.

27. The method of claim 26 wherein the identifying is effected after obtaining the second subset of carriers.

28. The method of claim 22 wherein at least some of the first plurality of rules are parameterized.

29. A machine-readable medium having encoded thereon machine-interpretable rules for underwriting life insurance, the rules comprising: a) basic rules, each basic rule applicable to a plurality of carriers; b) carrier-specific rules; and c) product-specific rules; wherein the rules enable a machine to automatically underwrite life insurance using a user profile for at least some users.

30. The medium of claim 29 wherein the rules are organized in a hierarchy, for each given topic, such that basic rules are evaluated prior to carrier-specific rules and carrier-specific rules are evaluated prior to product-specific rules.

31. The medium of claim 29 wherein at least some of the rules are parameterized.

32. The medium of claim 29 wherein at least some of the rules independently determine if the user can be underwritten.

33. The medium of claim 29 wherein at least some of the rules depend on information from an external provider.

34. The medium of claim 33 wherein the external provider is a medical examiner.

35. A method of querying a user about risk during evaluation for life insurance coverage comprising:
arranging at least one of a plurality of queries in a decision tree, such that a query precedes another query if it is more probable that an unacceptable answer to the rearranged query will result in excluding a user from purchasing insurance coverage; and
issuing at least one rearranged query from the decision tree to a user.

36. A server comprising a processor, memory, and a communication interface, wherein the communication interface exchanges information with a client system across a network, and the processor is configured to:
receive a first set of information about a user;
generate display information that enables a client system to display a first range of pricing information for a life insurance plan for the user to the user;
send the display information to the client system;
receive a second set of information about the user;
generate additional display information that enables the client system to display a second range of pricing information for the life insurance plan to the user;
send the additional display information to the client system
receive quotes for the life insurance plan from a plurality of insurance carriers; and
send the quotes to the user.

37. A server comprising a processor, and memory, wherein the memory stores rules for underwriting life insurance, the rules comprising: a) basic rules, each basic rule applicable to a plurality of carriers; b) carrier-specific rules; and c) product-specific rules; and the processor is configured to underwrite life insurance using a user profile.

38. The server of claim 37 in which the processor is further configured to generate pricing information for a plurality of carriers based on the underwriting and send the pricing information to a client system.

39. The server of claim 37 wherein the rules are organized in a hierarchy, and the processor is configured such that basic rules are evaluated prior to carrier-specific rules and carrier-specific rules are evaluated prior to product-specific rules.

40. The server of claim 37 wherein at least some of the rules independently determine if the user can be underwritten.
